(19) United States
(12) Patent Application Publication
(10) Pub. No.: US 2009/0128433 A1
(43) Pub. Date: May 21, 2009

(54) Antenna assembly

(75) Inventors: Joseph F. Lawlor, County Laoise (IE); Donal N. Carroll, Dublin (IE)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: Kavveri Technologies Inc., Markham, ON (CA)

(21) Appl. No.: 11/914,582

(22) PCT Filed: May 10, 2006
(86) PCT No.: PCT/EP06/04355

§ 371 Date: Aug. 26, 2008

(30) Foreign Application Priority Data
May 18, 2005 (GB) 0510096.2

(51) Int. Cl. H01Q 3/02; H02P 31/00

(52) U.S. Cl. 343/757; 318/3

(57) ABSTRACT

An antenna assembly (2) for a base station (3) of a radio telecommunications network comprises an antenna (8) attachable to a support structure (such as a mast (I)) so that the antenna (8) is pivotable relative to the structure (1) about a non-horizontal (preferably a vertical) axis. The assembly includes a motor (42) for causing controlled pivotal ball movement of the antenna (8) about said axis so as to adjust the azimuthal angle of the antenna. This enables a degree of remote control for the footprint of the antenna, thus facilitating the setting up possible adjustment of the network.

### FIELD OF THE INVENTION

This invention relates to an antenna assembly for base station of a radio telecommunications network, a plurality of antenna assemblies mounted on a support structure and to a base station of a radio telecommunications network.

### BACKGROUND TO THE INVENTION

A base station and its associated antenna (or antennas) provides a radio link between mobile units within the range of the antenna and the infrastructure of the telecommunications system. The area of coverage of the network is divided into a lattice of interleaving cells, each associated with a respective one or more antennas. The cells enable a large number of mobile units to use the network, despite limitations to the number of available of transmission/reception frequencies, since frequencies can be re-used in separate cells.

The latest generation of mobile telecommunications systems uses code division multiple access (CDMA) to enable multiple communications links to be set up between mobile units and the base stations. Neighbouring cells of a CDMA system are more likely to re-use available frequencies than telecommunications systems which use other types of multiple access protocol (for example frequency or time division multiple access), and as a result the system can be vulnerable to interference between the cells unless the overlap between them is kept to a minimum. On the other hand, there does have to be sufficient overlap to enable a hand over of communications links in the case of mobile units passing from one cell to a neighbouring cell.

Accordingly, once a lattice of base stations and associated antennas of a modern radio telecommunications system has been installed, it is usually necessary to adjust the footprint of the cells in order to optimise the set-up of the network.

It is known to adjust the footprint of a given cell by means of a phase shifter in the antenna. The phase shifter alters the beam tilt of the antenna, and hence the cell footprints. Known antenna mountings also allow the azimuth of individual antennas to changed within, for example, a range of plus or minus 15°. However, such adjustment involves loosening of fasteners and manually moving the antenna to the desired bearing, operations which require site outage and a rigging team. Furthermore, since the antennas are likely to be located at elevated positions, such manual adjustment is not an easy practice.

### SUMMARY OF THE INVENTION

According to a first aspect of the invention, there is provided an antenna assembly for a base station of a radio telecommunications network, the assembly comprising an antenna, and being attachable to a support structure so that the antenna is pivotable relative to the structure about a substantially vertical axis, the assembly including a motor for causing controlled pivotable movement of the antenna about said axis so as to adjust the azimuthal angle of the antenna.

Since the antenna is, in use, pivotably mounted and can be pivoted by the operation of the motor, the invention allows the azimuthal angle of the antenna to be adjusted remotely, by operating the motor. Thus an operative does not need to be able physically to reach the antenna (for example by climbing the support structure) to make this adjustment. In one example, an operative may operate the motor by means of controls at the base of a support structure, such as an antenna mast, on which the assembly is mounted.

Preferably, however, the assembly includes a control module connected to the motor and the base station and operable to operate the motor in response to control signals received by the base station over the network. Typically, the azimuthal adjustment of the antenna would occur on setting up of the network, but further tuning of the azimuthal angle may occur as a result of a subsequent modification/upgrades to the network which require a different cell footprint.

Preferably, the antenna comprises an array of radiating/receiving elements, the motor being operable to pivot said array.

Preferably, the array is linear and, with the antenna mounted on a support structure, is substantially vertical.

The assembly preferably includes mounting means on which the antenna is pivotably mounted, the mounting means being attachable to a support structure so that the antenna is, in use, attached to the said structure through the mounting means.

In this case, the motor is preferably operable to pivot the antenna relative to the mounting means, thereby to adjust said azimuthal angle.

The motor is conveniently fixed relative to the mounting means and acts on the antenna through a transmission which conveniently comprises a plurality of gears.

The assembly preferably includes one or more sensors for detecting the azimuthal angle of the antenna.

Such sensors may comprise single position detectors for determining whether the antenna is at a predetermined azimuthal angle, for example whether the antenna is set at either limit of its range of allowable pivotable movement.

Such detectors can provide positional feedback from which other positions of the antenna can be inferred from the control signals transmitted to the motor to move the antenna out of the predetermined position. The detectors help to avoid cumulative errors in position caused by discrepancies between the actual and intended degrees of adjustment of azimuthal angle by the motor.

Preferably, the detectors comprise end stops for limiting the extent of allowable movement of the antenna, and a current sensor for determining whether current through the motor is greater than a given threshold.

Thus, the current sensors are responsive to the increase in current through the motor indicative of the drop in back emf caused by the movement of the motor prevented by an end stop.

Preferably, the sensors include a position sensor for determining the azimuthal position of the antenna between the limits of its range of allowable pivotable movement.

Such a sensor may to advantage be operable to provide a continuous measurement of position of the antenna.

To that end, the position sensor may comprise a potentiometer for generating a continuous variable voltage signal, the instantaneous value of which is representative of the azimuthal position of the antenna.

Such a sensor may be used in conjunction with end stops detectors the latter providing data for calibrating the output of the potentiometer.

Preferably, the assembly includes a remotely operable phase shifter for controlling the beam elevation of the antenna array. It has already been proposed to use remotely operable phase shifters to adjust the cell footprint of a mobile telecommunications system. However, by providing the facility for varying both beam tilt and azimuthal angle, the invention provides considerably more flexibility in terms of adjustment than can be achieved by adjustment of beam tilt alone.

Preferably, the phase shifter is of a type which provides a continuously variable adjustment of the relative phases of signals at the elements of the antenna array, thereby to provide the facility for selecting any beam angle within a continuous range of possible angles.

The invention also lies in a plurality of antenna assemblies, each as described above, and a support structure on which the assemblies are mounted, the support structure comprises a mast, the antenna assembly being disposed in angularly spaced positions around the mast.

Furthermore, the invention also lies in a base station of a radio telecommunications network, the base station having at least one antenna assembly as herein above described.

### BRIEF DESCRIPTION OF THE DRAWINGS

The invention will now be described, by way of example only, with reference to the accompany drawings, in which:—

FIGS. 1 and 2 show two different types of antenna mast, on each of which is mounted three antenna assemblies, each in accordance with the present invention;

FIG. 3 is an exploded perspective view of the lower portion of one such antenna assembly;

FIG. 4 is a circuit diagram of a sensor forming part of the assembly;

FIG. 5 is a block diagram of the control system of the antenna assembly; and

FIG. 6 is a similar diagram showing the control systems of the three antenna assemblies of one mast.

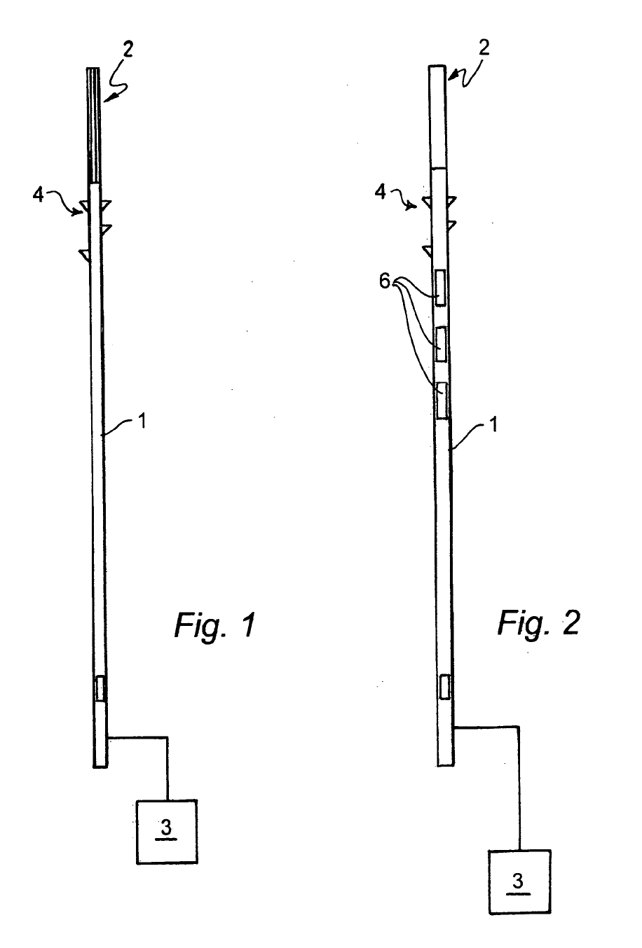

With reference to FIGS. 1 and 2, in which like reference numerals are used to indicate corresponding components, a mast 1 is topped by three antenna assemblies, generally referenced 2, mounted at equiangular intervals (i.e. 120°) about the mast 1. Both masts also include a series of climbing rungs, some of which are shown at 4, whilst the mast shown in FIG. 2 also houses three mast head amplifiers 6, one for each respective antenna assembly. The three antenna assemblies are contained in a cylindrical radome (not shown) mounted on top of the mast 1. Each mast forms part of a respective base station, the other elements of which are diagramatically represented by block 3.

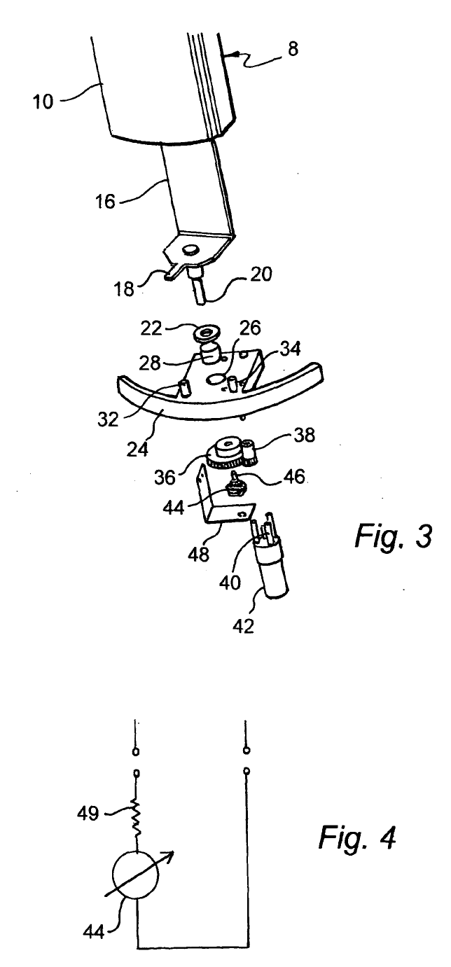

Since the three antenna assemblies are identical, only one will be described in detail. With reference to FIG. 3, that assembly comprises an antenna 8 which takes the form of a linear array of radiating patches housed within an antenna radome 10.

The radome 10 is initially open at both ends to allow the contained components to be inserted or removed, and (in use) is closed at its top by a protective cap (not shown). The radiating patch assembly is of the kind currently sold by the present applicants, and is substantially as described in their UK Patent specification No. GB2364175B. The assembly thus comprises a linear array of radiating patch sub-assemblies mounted via dielectric spacers on an elongate panel the upper surface of which is coated in copper and the lower surface of which has a feed/reception network of transmission lines connecting each patch sub-assembly to a respective feed port on a phase shifter also contained in the radome 10.

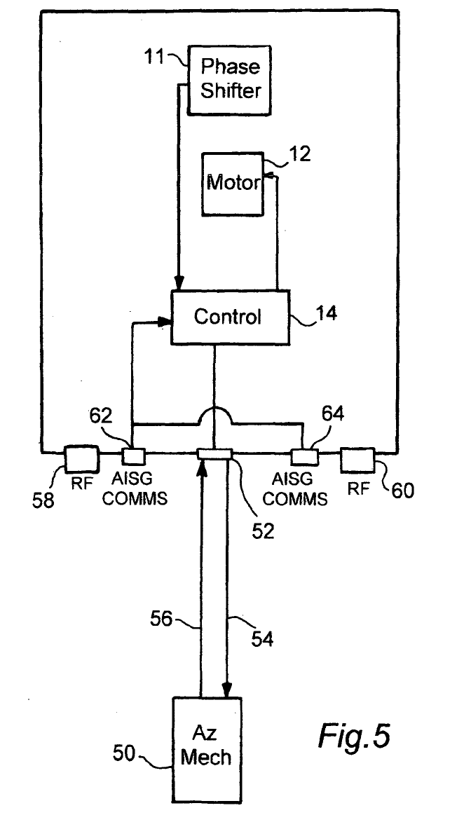

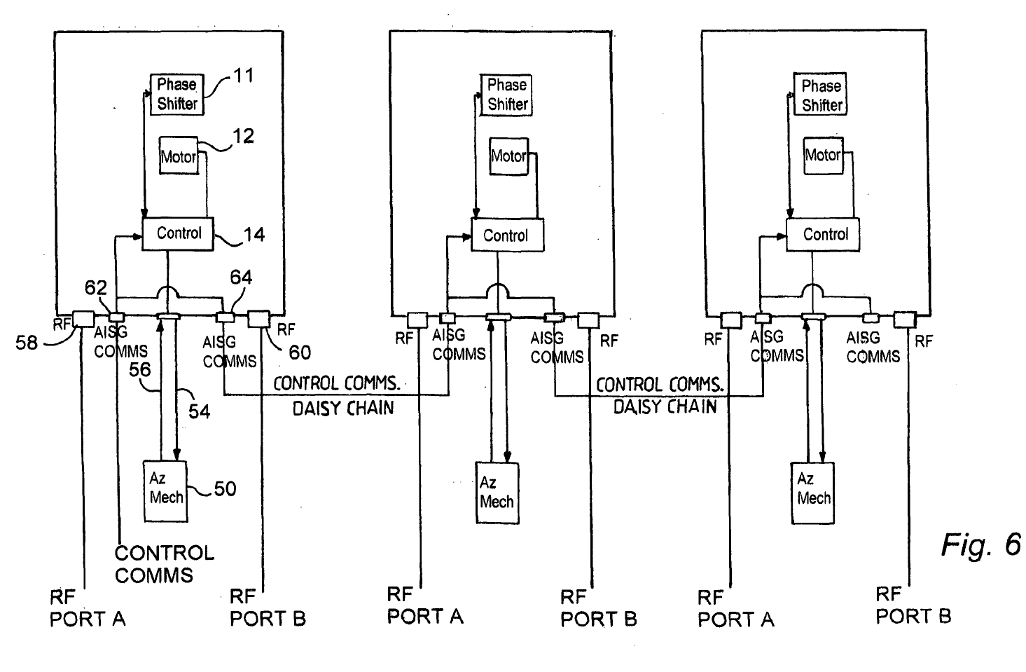

The phase shifter (11 in FIGS. 5 and 6) comprises a pair of microstrip antenna phase shifters, one for each respective polarity of signals sent/received by the radiating patch assembly. The relative phases of signals of the input/output ports of the phase shifter assembly are controlled by means of a common dielectric slider which is slideably mounted between the two phase shifters and is connected to a motor (referenced 12 in FIGS. 5 and 6) by means of a worm drive. The linear position of slider and the angular position of the output shaft of the motor are monitored by means of an opto-electronic feedback system which uses a series of LEDs and phototransistors in the housing connected to the phase shifter assembly by means of fibre optic cables. The form and function of the phase shifter assembly, motor and phase shifter feedback system are as described in the applicant's existing PCT Patent Application No. PCT/EP2004/006054, the contents of which are incorporated herein by reference.

The operation of the phase shifter motor 12 is governed by a control board 14 also in the radome 10. The antenna 8 is mounted on an antenna 16 which is substantially L-shaped in profile, and which includes a radial finger 18 which extends horizontally from the base of the bracket 16. Extending vertically from the underside of the bracket 16 is a pivot pin 20 which extends through a thrust bearing 22 through which the base of the bracket 16, and hence the antenna 8 is supported on a bottom support bracket 24.

The bracket 24 includes an aperture 26 which accommodates a roller bearing 28 and through which the pin 20 extends so that the antenna 8 is pivotable on the lower bracket 24 about the axis of the pin 20. The upper portion of the antenna 8 is also provided with a pivot pin which is coaxial with the pin 20 and through which the antenna is mounted on a upper port bracket (not shown).

Projecting vertically upwards from the bottom support bracket 24 are a pair of end stop pins 32 and 34 which co-operate with the finger 18 to define the limits to the range of allowable pivoting movement of the antenna 8 on the bracket 24.

A portion of the pin 20 extends beyond the bottom of the support bracket 24 and is fixed to a first gear wheel 36 which is angularly fixed to the pin 20 so as to rotate with the antenna 8. The cog 36 meshes with the a drive cog 38 connected directly to the output 40 of an electric servo motor 42.

A potentiometer 44 is situated immediately beneath the step down cog 36 with its input shaft 46 coaxially attached to the cog 36. The body of the potentiometer 44 is attached to a potentiometer support bracket 48 which is, in term, attached to the bottom support bracket 24. Consequently, the input shaft 46 rotates with the cog 36 so that pivotable movement of the antenna 8 will vary the voltage output provided by the potentiometer 44. As can be seen from FIG. 4, the potentiometer 44 is connected in series with a resistor 49. The value of the resistor 49 is used to provide an identification of the antenna assembly from the three assemblies on the mast, so that the value of that resistance on each assembly will differ from those of the other two assemblies. The total resistance (i.e. the sum of the potentiometer 44 and resistor 49 resistances) thus lies in a respective range which does not overlap either of the other two ranges.

In FIG. 5, the motor 42 and the potentiometer 46 are collectively referenced 50 and are connected to an input/output port 52 of the control board 14. The board sends control signals to the motor 42 causing the latter to rotate the cog 38, and hence the cog 36. This connection is indicated by arrow 54. Arrow 56 indicates the connection between the output of the potentiometer 44 and the input of the board 14. The arrow also indicates the connection of the motor 50 to current monitoring circuitry on the board 14, which circuitry determines whether the current flowing through the armature of the motor 42 exceeds a pre-determined threshold (in this case 600 milliamps).

The antenna assembly also includes two RF input/output ports, 58 and 60, which are, in use, connected to the base station through RF feeder cable. The ports 58 and 60 are also connected to the signal input/output terminals of the phase shifter assembly 11. The assembly further includes two AISG input/output ports 62 and 64 which can be connected in the way shown in FIG. 6 to the corresponding ports of the other two antenna assemblies on the mast to provide an AISG protocol data signal bus. This bus is, in use, supplied with control signals (extracted from the telecommunications system by the base station) for controlling the operation of the motors 42 and 11, and for obtaining feedback data from the phase shifter assembly and the potentiometer on the measured beam elevational angle and antenna azimuth. The latter angle is represented by a digitised resistance value (obtained from an ADC on the control board), which also identifies the antenna assembly concerned by virtue of the resistance of the identifying resistor 49 which is superimposed on the output value from the potentiometer 44.

After installation of the antenna assemblies, the base station can initiate a calibration procedure (for each assembly), during which each motor 42 moves its respective antenna until it can move no more, i.e. the finger 18 is hard-up against one of the pins 32 and 34. At that stage, the current drawn by the motor rapidly increases, and this is taken as a flag for the end of travel. The circuitry on the board 14 monitors the currents drawn by the motor and if it exceeds approximately 600 milliamps at 24 volts an end of travel flag is set. The motor is then operated in the reversed direction until the finger 18 abuts the other of the two pins 32 and 34. The resistance of the circuit of FIG. 4 is noted at both extremes. Since the potentiometer 44 gives a linear resistance versus angle readout, the angle of the mechanism can then be determined by the resistance of the circuit.

1. An antenna assembly for a base station of a radio telecommunications network, the assembly comprising an antenna, and being attachable to a support structure so that the antenna is pivotable relative to the structure about a non-horizontal axis, the assembly including a motor for causing controlled pivotable movement of the antenna about said axis so as to adjust the azimuthal angle of the antenna.

2. An antenna assembly according to claim 1, in which said axis is substantially vertical.

3. An assembly according to claim 1, in which the assembly includes a control module connected to the motor and the base station and operable to operate the motor in response to control signals received by the base station over the network.

4. An assembly according to claim 1, in which the antenna comprises an array of radiating/receiving elements, the motor being operable to pivot said array.

5. An assembly according to claim 4, in which the array is linear and, with the antenna mounted on a support structure, is substantially vertical.

6. An assembly according to claim 1, in which the assembly includes mounting means on which the antenna is pivotably mounted, the mounting means being attachable to a support structure so that the antenna is, in use, attached to the said structure through the mounting means.

7. An assembly according to claim 6, in which the motor is operable to pivot the antenna relative to the mounting means, thereby to adjust said azimuthal angle.

8. An assembly according to claim 6, in which the motor is fixed relative to the mounting means.

9. An assembly according to claim 8, in which the motor acts on the antenna through a transmission which comprises a plurality of gears.

10. An assembly according to claim 1, in which the assembly includes one or more sensors for detecting the azimuthal angle of the antenna.

11. An assembly according to claim 10, in which the sensors comprise end stops for limiting the extent of allowable movement of the antenna, and a current sensor for determining whether current through the motor is greater than a given threshold.

12. An assembly according to claim 10, in which the sensors include a position sensor for determining the azimuthal position of the antenna between the limits of its range of allowable pivotal movement.

13. An assembly according to claim 12, in which the position sensor is operable to provide a continuous measurement of position of the antenna.

14. An assembly according to claim 13, in which the position sensor comprises a potentiometer for generating a continuous variable voltage signal, the instantaneous value of which is representative of the azimuthal position of the antenna.

15. An assembly according to claim 1, in which the assembly includes a remotely operable phase shifter for controlling the beam elevation of the antenna array.

16. An assembly according to claim 15, in which the phase shifter is of a type which provides a continuously variable adjustment of the relative phases of signals at the elements of the antenna array, thereby to provide the facility for selecting any beam angle within a continuous range of possible angles.

17. A plurality of antenna assemblies, each in accordance with claim 1, and a support structure on which the assemblies are mounted, the support structure comprising a mast, the antenna assemblies being disposed in angularly spaced positions around the mast.

18. A base station of a radio telecommunications network, the base station having at least one antenna assembly in accordance with claim 1.
